(19) United States
(12) Patent Application Publication
(10) Pub. No.: US 2008/0147569 A1
(43) Pub. Date: Jun. 19, 2008

(54) REAL TIME TRADING OF FOREIGN FINANCIAL INSTRUMENTS IN LOCAL CURRENCY

(75) Inventors: MICHAEL ALAN KAHAN, AUSTIN, TX (US); JOHN MORGAN SLADE, FORT WORTH, TX (US); DANIEL SETH WILLIAMS, FLOWER MOUND, TX (US); GRANT MARCUS TAYLOR, DALLAS, TX (US); RALPH BRUCE FERGUSON, ROUND ROCK, TX (US)

Correspondence Address: RATNERPRESTIA, P O BOX 980, VALLEY FORGE, PA, 19482-0980, US

(73) Assignee: PENSON WORLDWIDE, INC., DALLAS, TX (US)

(21) Appl. No.: 11/950,081

(22) Filed: Dec. 4, 2007

Related U.S. Application Data
(60) Provisional application No. 60/872,743, filed on Dec. 4, 2006.

(51) Int. Cl. G06Q 40/00

(52) U.S. Cl. 705/36 R; 705/400; 705/37

(57) ABSTRACT

A method for producing quotes in a first currency for a financial instrument traded in a second currency. At least one substantially real time series of currency conversion quotes for converting the second currency to the first currency is received. This series of currency conversion quotes is applied to a currency conversion model adapted to estimate future currency conversion quotes. An offered conversion price within a settlement time window is determined using the estimated future currency conversion quotes. The settlement time window begins at the current time and extends through the financial instrument settlement period. A substantially real time series of quotes for the financial instrument, in the second currency, is received. A substantially current time quote for the financial instrument is multiplied by the offered conversion price to determine a hedged quote for the foreign financial instrument in the first currency. The hedged quote is displayed.

### CROSS-REFERENCE TO RELATED APPLICATIONS

This application claims priority of U.S. Provisional Patent Application No. 60/872,743, filed Dec. 4, 2006, which is herein incorporated by reference.

### FIELD OF THE INVENTION

The present invention concerns a method of trading foreign financial instruments in local currency. In particular, this method may allow for providing real time quotes of foreign financial instruments in local currency. These real time quotes may be fully or partially hedged.

### BACKGROUND OF THE INVENTION

Many investors may wish to hold some foreign equities. Just as U.S. companies issue ownership interests in the form of stock, so do companies abroad.

The risks and rewards of foreign stock markets are similar to those of the U.S. stock market, but they are frequently magnified. This tends to make them subject to wider price swings. There are a variety of reasons for this. These reasons may include political instability or the fact that many foreign markets are smaller than the U.S. market and their stocks may be more thinly traded. In addition, investors who buy foreign equities face currency risk.

When an investor buys foreign stock (or other foreign financial instruments), they buy the shares with that country's currency. When the investor sells them, they get paid in that country's currency too. Before the investor can make these trades, they have to convert the currencies at the going exchange rate. These exchange rates vary day to day based on the relative strength of any given country's balance sheet and the interest rates that country is paying on government securities, among other reasons.

When purchasing a financial instrument, there is typically a period between placing the order and settlement. If the value of the currency conversion rate rises during this settlement period, the investor profits by waiting to exchange the currency when buying the financial instrument, but loses when selling. If the currency conversion rate falls, the investor loses by waiting when buying, but gains when selling. In some cases, currency swings can be more significant to the investor's total return than the actual appreciation or depreciation of the particular financial instrument.

Thus, it is desirable for the investor to optimize the timing of their currency conversion to gain the maximum profit potential from their foreign exchange investing.

Additionally, because the eventual price paid, or received, by the investor in their local currency depends on both quotes for the foreign financial instrument in its own currency and the currency conversion rate; the investor may find tracking foreign financial instruments to determine investment strategies more complex than tracking domestic financial instruments. Thus, a simplified method of monitoring the quotes for foreign financial instruments converted into the local currency is also desirable.

The present invention may assist investors in both tracking and optimizing the investments in foreign investment financial instruments.

### SUMMARY OF THE INVENTION

An exemplary embodiment of the present invention is a method for producing quotes in a first currency for a financial instrument traded in a second currency. At least one substantially real time series of currency conversion quotes for converting the second currency to the first currency. The at least one substantially real time series of currency conversion quotes is applied to a currency conversion model adapted to estimate a plurality of future currency conversion quotes. An offered conversion price for converting the second currency to the first currency within a settlement time window is determined using the estimated future currency conversion quotes. The settlement time window begins at the current time and extends through the financial instrument settlement period. A substantially real time series of quotes for the financial instrument is received. These quotes are in the second currency. A quote for the financial instrument substantially corresponding to the current time is multiplied by the offered conversion price to determine a hedged quote for the foreign financial instrument in the first currency. The hedged quote for the foreign financial instrument is displayed.

Another exemplary embodiment of the present invention is a method for purchasing a financial instrument traded in a first currency using a second currency in which a predetermined amount of the first currency is purchased with the second currency to settle the order for the financial instrument, which was placed in the first currency. At least one substantially real time series of currency conversion quotes is applied to a currency conversion model. The currency conversion model is adapted to estimate a plurality of future currency conversion quotes and risk values associated with the plurality of future currency conversion quotes. Each of these future currency conversion quotes includes a conversion price and a transaction time. An algorithm that includes parameters for the future currency conversion quotes and their associated risk values is used to determine an expected transaction time. The expected transaction time is before the settlement time of the order and is determined to obtain the minimum conversion price within a set of risk criteria. The at least one substantially real time series of currency conversion quotes is applied to a currency conversion model and the algorithm is used to update the expected transaction time until the current time is approximately the expected transaction time. Once the current time is approximately the expected transaction time, the predetermined amount of the first currency is purchased with the second currency at the best current conversion price.

### BRIEF DESCRIPTION OF THE DRAWINGS

The invention is best understood from the following detailed description when read in connection with the accompanying drawings. Included in the drawing are the following figures:

FIG. 1 is a block diagram illustrating exemplary methods of transacting foreign financial instruments in local currency according to the present invention.

FIG. 2 is a flowchart illustrating an exemplary method of producing quotes in a first currency for a financial instrument that is traded in a second currency according to the present invention.

FIG. 3 is a flowchart illustrating an exemplary method of purchasing a financial instrument that is traded in a first currency using a second currency according to the present invention.

### DETAILED DESCRIPTION OF THE INVENTION

Trading financial instruments in a foreign market involves additional complexities compared to trading financial instrument in one's own country. Bid and ask quotes, as well as the actual trade prices, are provided in the currency of the foreign market, not the local currency with which the trader is familiar. For example, if a South African trader wishes to trade in Coca Cola® stock on the New York Stock Exchange®, the quotes and prices will be provided in US dollars, not rands. The South African trader will also need to determine the currency conversion price for rands to US dollars. Adding to the complexity is the fact that the currency is needed when the trade is settled, not when the order is placed. In the case of trades placed on the New York Stock Exchange®, for example, settlement occurs three business days after the order is placed. Because the currency conversion price between the local currency and the currency of the foreign market may fluctuate between when the order is placed and when the trade is settled, the effective price of the financial instrument in the local currency may fluctuate between when the order is placed and when the trade is settled, even though the actual price of the financial instrument in the currency of the foreign market was locked in when the order was placed. Thus, the foreign exchange trader has to also decide when to purchase the foreign currency. Should they purchase the currency immediately to lock in the local currency price of the financial instrument, or should they wait so as not to tie up their assets in the foreign currency sooner than necessary and/or to possibly obtain a better currency conversion price?

Exemplary embodiments of the present invention include methods for producing quotes in a first currency for a financial instrument traded in a second currency and methods for purchasing a financial instrument traded in a first currency using a second currency. The financial instruments may include: stocks, bonds, commodities, equity instruments, derivative securities, and/or futures.

It is noted that the term local currency, as used in the present application, refers to the currency in which the client wishes to receive spot and/or hedged quotes, and not necessarily the country in which the client resides (although this may be the most common case). Certain clients may even desire to receive spot and/or hedged quotes in more than one local currency.

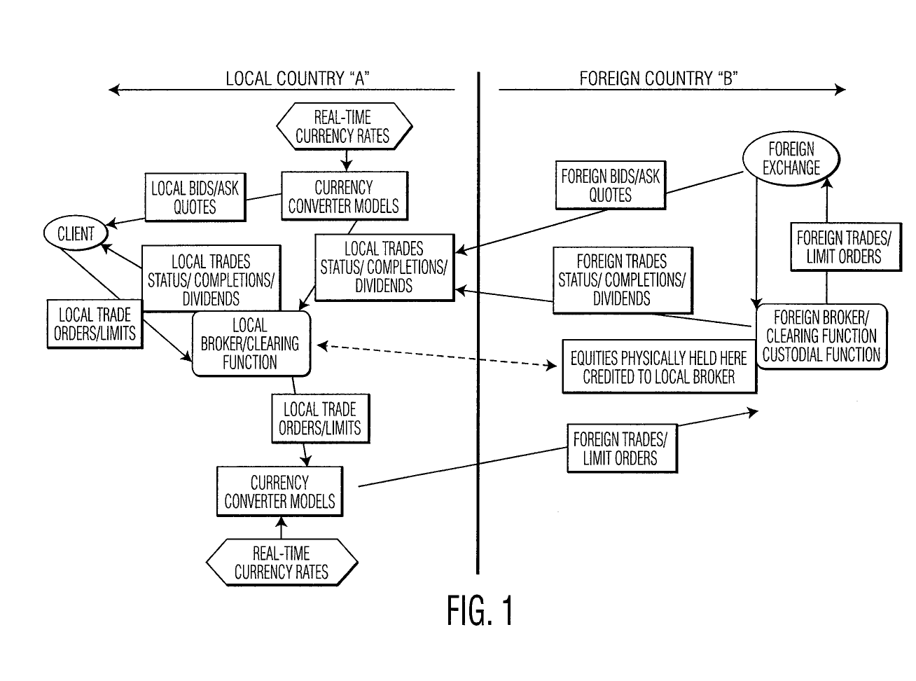

FIG. 1 is a block diagram that illustrates the connections between various elements of exemplary embodiments of the present invention. Arrows in this exemplary block diagram illustrate flows of information.

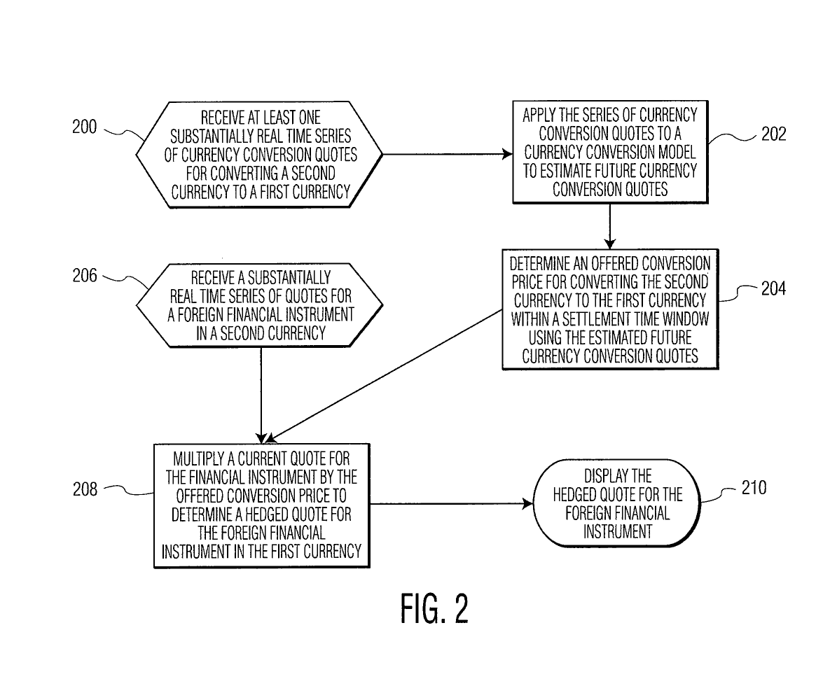

FIG. 2 illustrates one exemplary embodiment of the present invention, an exemplary method for producing quotes in the local currency of the trader for a financial instrument that is being traded in another currency (the foreign currency).

At least one substantially real time series of currency conversion quotes for converting the foreign currency to the local currency is received, step 200. These series of currency conversion quotes may be received from various banks and/or financial institutions, depending on which currencies are to be exchanged. The substantially real time series of currency conversion quotes are applied to a currency conversion model, step 202. This currency conversion model may be any one of number of currency conversion models adapted to estimate future currency conversion quotes, such as the currency conversion models described in U.S. patent application Ser. No. 11/263,508, filed Oct. 31, 2005. The estimated future currency conversion quotes desirably include an expected time for the estimated quotes. The currency conversion model may further estimate risk values associated with the future currency conversion quotes.

An offered conversion price for converting the foreign currency to the local currency within a settlement time window is determined using the current or estimated future currency conversion quotes, step 204. The settlement time window is the time period between the current time when the offered conversion price is being determined and the settlement time for the financial instrument. Thus, the settlement time window extends for the settlement period of the financial instrument, typically two or three business days.

The offered conversion price may be determined using an algorithm that includes parameters for the current or estimated future currency conversion quotes. This algorithm may also include parameters for risk values associated with the future currency conversion quotes, if the currency conversion model is adapted to estimate risk values associated with the future currency conversion quotes. The algorithm desirably determines a best estimated conversion price within the settlement time window and an associated commission price. The commission price accounts for risk being taken and the period of time that the currency would be tied up between the estimated purchase time and the settlement, as well as including fee for the currency conversion services. The commission price may also take into account the nature of the trader (e.g., a large, important Client, as, illustrated in FIG. 1, versus a small investor) and/or the size of the trade to be placed. As used herein, the terms “trader, “client” and “customer” are considered equivalent terms. The best estimated conversion price is then added to the associated commission price to obtain the offered conversion price. It is noted that the best estimated conversion price is the conversion price that leads to the lowest offered conversion price, not necessarily the lowest estimated conversion price.

A substantially real time series of quotes for the financial instrument is received. The quotes may be bid quotes and/or ask quotes and are provided in the foreign currency, step 206.

The current quote of the substantially real time series of quotes for the financial instrument is multiplied by the offered conversion price to determine a hedged quote for the foreign financial instrument in the local currency, step 208. This hedged quote for the foreign financial instrument is then displayed so that the trader can determine if they wish to place an order, step 210. The displayed hedged quote is a quote in the local currency that the trader may use without further calculation or uncertainty. All risk to the trader has been subsumed into the commission price associated with the best estimated conversion price.

A trader may also wish to see a spot quote for the financial instrument displayed along side the hedged quote. The spot quote may be calculated by selecting a spot currency conversion quote from the substantially real time series of currency conversion quotes, the currency conversion quote being a best quote for converting the foreign currency to the local currency at approximately the current time. The spot currency conversion quote is then multiplied by the current quote of the substantially real time series of quotes for the financial instrument to determine a spot quote for the foreign financial instrument in the local currency.

The trader may then place an order in the local currency for an amount of the foreign financial instrument using the hedged quote. This order may be accepted and filled using the hedged quote, without any further complications for the client. This exemplary method provides simplicity and certainty to the client.

Alternatively, the client may select a hedge percentage of the order to be filled using the hedged quote. The remainder of the order is to be filled using the current foreign currency quote for the financial instrument and a settlement conversion price. The settlement conversion price based on the best currency conversion quote for converting the foreign currency to the local currency at a settlement time of the order. This price is, therefore, unknown at the time the order is placed and adds some complexity and risk to the trade. However, the risk can be somewhat mitigated by selecting a higher hedge percentage.

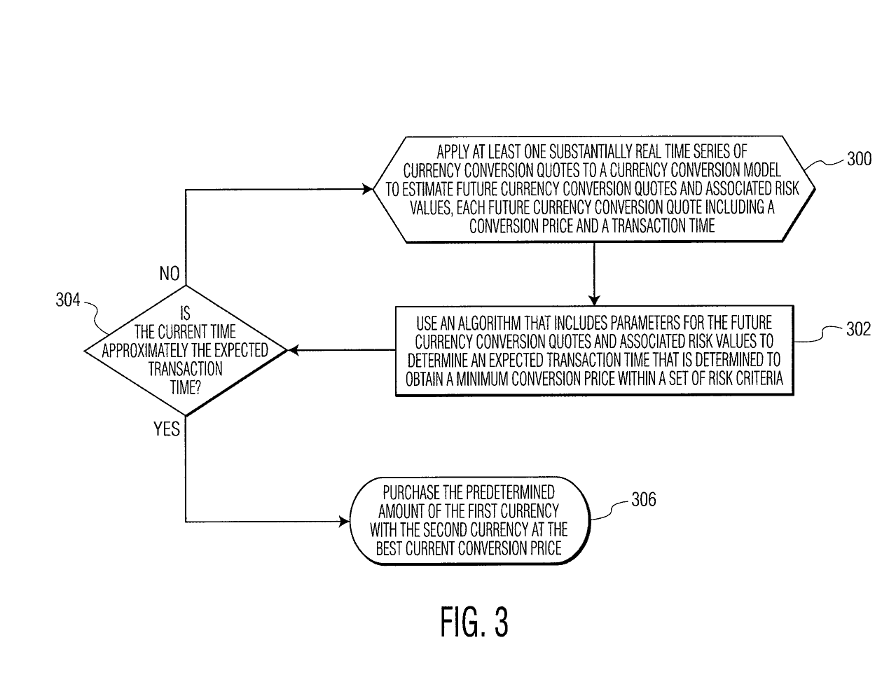

FIG. 3 illustrates an exemplary method for purchasing a financial instrument traded in a foreign currency using local currency, according to the present invention. In this exemplary method, a predetermined amount of the foreign currency is to be purchased with local currency to settle an order for the financial instrument that was placed in the foreign currency.

At least one substantially real time series of currency conversion quotes is applied to a currency conversion model that is adapted to estimate a plurality of future currency conversion quotes and a plurality of risk values associated with the plurality of future currency conversion quotes, step 300. This currency conversion model may be any of the types of currency conversion models described above. Each future currency conversion quote includes a conversion price and a transaction time.

An expected transaction time for the currency transaction is determined using an algorithm that includes parameters for the future currency conversion quotes and the associated risk values estimated by the currency conversion model, step 302. This algorithm may also include a parameter for the amount of foreign currency to be purchased. The expected transaction time occurs before the settlement time of the order. It is desirably determined such that a minimum conversion price may be obtained within a set of risk criteria. The set of risk criteria may depend on a number of factors, such as the amount of foreign currency to be purchased and/or the time period between the current time and the settlement time.

The expected transaction time is compared to the current time, step 304. Desirably, the at least one substantially real time series of currency conversion quotes continues to be applied to a currency conversion model so that the expected transaction time may be updated. This process continues until the expected transaction time is approximately the current time, at which point the predetermined amount of foreign currency is desirably purchased with local currency at a best currently available conversion price, step 306.

It is noted that it may be desired to purchase the foreign currency in several partial purchase portions to somewhat mitigate the risk of waiting for a particularly low conversion price, without completely missing such potential opportunities. If such a scheme is desired, the set of risk criteria may include several subsets of partial purchase risk criteria. Each subset of partial purchase risk criteria is associated with a partial purchase of the predetermined amount of the foreign currency. These subsets of risk criteria vary to account for the portion of the overall amount of foreign currency that has already been purchased.

The subsets of partial purchase risk criteria are selected in order and the expected transaction time for selected subset is determined and updated until that corresponding portion of the predetermined amount of the foreign currency is purchased. The selected subset of partial purchase risk criteria is removed from the set of risk criteria and next subset is selected and a new expected transaction time determined. This process continues until the entire predetermined amount of the foreign currency has been purchased.

It is noted that the exemplary currency conversion methods of the present invention may also be used to automatically convert any dividends that may be earned, and any other fees or earnings, to the local currency of the owner of the financial instrument. By automatically performing these currency conversions, exemplary embodiments of the present invention reduce the complexities of trading and owning foreign financial instruments.

FIG. 1 is a block diagram illustrating an exemplary embodiment of a foreign exchange (FX) system using exemplary methods of the present invention. Although this exemplary system illustrates one projected configuration of components, users and operators, it is not intended to be limiting.

FIG. 1 is divided between a Local Country “A” and a Foreign Country “B” to illustrate exemplary locations where its various components may reside and/or exemplary functions may be performed. These countries correspond to the local currency and the foreign currency previously discussed in the exemplary methods described above.

The only feature of FIG. 1 that must reside in the particular country shown is the foreign exchange, which serves to define Foreign Country “B.” However, for practical purposes, certain other features of the exemplary system of FIG. 1 may have to reside in a particular country due to laws and/or regulations relating to the trade of the selected financial instrument in these countries or laws relating to the currency of the countries. For example, most exchanges require the entity (or entities) performing the brokerage, clearing, and/or custodial functions to be registered with the exchange. Such entities are often subject to licensing by the country in which the exchange resides as well and are typically required to hold citizenship (as an individual or a corporate entity) within the country. Thus, the entity (or entities) performing the foreign brokerage, clearing, and/or custodial functions in an exemplary FX system of the present invention may usually be located in the same country as the foreign exchange. As another example of the effects of the laws of either Local Country “A” or Foreign Country “B” on exemplary embodiments of the present invention, the exportation of Brazilian real outside of Brazil is against Brazilian law. Therefore, if either the local currency or the foreign currency used in exemplary methods of the present invention is the Brazilian real, then the currency conversion must take place in Brazil to avoid violating Brazilian law.

It is contemplated that the currency converter models may reside in any country, even a Country “C” (not shown). For example, it may be desirable to operate currency conversion models for numerous currencies from one central location and to provide spot and/or hedged quotes in a variety of local currencies for a selection of financial instrument traded on exchanges in several foreign countries from that single location.

The local broker typically provides the spot and/or hedged quotes to the client. The entity (or entities) performing the local broker and clearing functions may also act as guarantor to the foreign broker that the trades will be concluded and may perform the currency conversion. It is, thus, desirable for the local broker and clearing functions to be performed in the country in which the client resides. However, these functions may be required to be performed by an entity (or entities) that reside in Local Country “A” due to laws and regulations regarding currency transactions.

The financial modeling and calculations involved in various exemplary embodiments of the present invention may be carried out through the use of a general-purpose computer system programmed to perform the steps of the exemplary methods described above. Exemplary general-purpose computer systems may include personal computers, work stations, distributed processing computer networks, and parallel processing computer systems. Parallel or distributed processing may be desirable for substantially real time applications involving the substantially concurrent prediction of future quotes for a plurality of currencies. Dedicated special-purpose computing systems may also be designed for performing exemplary methods of the present invention as well.

The inventors note that, in the case when the financial instruments being traded are futures, additional complexities may arise. This is because futures involve ongoing trading rights at a fixed price in the foreign currency; however, the corresponding local currency price may fluctuate due to fluctuations in the currency exchange rate during the time period of the future. Thus, focusing purely on quoting and trading may disregard some of the post-trade transaction complexities involved in the use of these financial instruments in exemplary embodiments of the present invention.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for producing quotes in a first currency for a financial instrument traded in a second currency, the method comprising the steps of:
a) receiving at least one substantially real time series of currency conversion quotes for converting the second currency to the first currency;
b) applying the at least one substantially real time series of currency conversion quotes to a currency conversion model adapted to estimate a plurality of future currency conversion quotes;
c) determining an offered conversion price for converting the second currency to the first currency within a settlement time window using the plurality of estimated future currency conversion quotes, the settlement time window beginning at a current time and extending for a financial instrument settlement period;
d) receiving a substantially real time series of quotes for the financial instrument, quotes of the substantially real time series of quotes being in the second currency;
e) multiplying i) a quote of the substantially real time series of quotes for the financial instrument substantially corresponding to the current time by ii) the offered conversion price to determine a hedged quote for the foreign financial instrument in the first currency; and
f) displaying the hedged quote for the foreign financial instrument.

2. The method according to claim 1, wherein determining the offered conversion price in step (c) includes:
c1) using an algorithm that includes parameters for the plurality of future currency conversion quotes estimated in step (b) to determine a best estimated conversion price within the settlement time window and an associated commission price; and
c2) adding the best estimated conversion price to the associated commission price to obtain the offered conversion price.

3. The method according to claim 1, wherein:
the currency conversion model is further adapted to estimate a plurality of risk values associated with the plurality of future currency conversion quotes; and
determining the offered conversion price in step (c) includes using an algorithm that includes parameters for the plurality of future currency conversion quotes estimated in step (b) and the plurality of risk values associated with the plurality of future currency conversion quotes to determine a best estimated conversion price within the settlement time window.

4. The method according to claim 1, further comprising the steps of:
g) accepting an order placed in the first currency for an amount of the foreign financial instrument from a client, the order to be filled using the hedged quote.

5. The method according to claim 4, wherein determining the offered conversion price in step (c) includes using an algorithm that includes parameters for the plurality of future currency conversion quotes estimated in step (b) and the amount of the order accepted in step (g).

6. The method according to claim 1, further comprising the steps of:
g) selecting a spot currency conversion quote from the substantially real time series of currency conversion quotes, the currency conversion quote being a best quote for converting the foreign currency to the local currency at approximately the current time;
h) multiplying i) the quote of the substantially real time series of quotes for the financial instrument substantially corresponding to the current time by ii) the spot currency conversion quote to determine a spot quote for the foreign financial instrument in the second currency; and
i) displaying the spot quote for the foreign financial instrument.

7. The method according to claim 6, further comprising the steps of:
j) accepting an order placed in the first currency for an amount of the foreign financial instrument from a client; and
k) allowing the client to select a hedge percentage of the order to be filled using the hedged quote, the remainder of the order to be filled using the quote of the substantially real time series of quotes for the financial instrument substantially corresponding to the current time and a settlement conversion price, the settlement conversion price based on a best currency conversion quote for converting the second currency to the first currency at a settlement time of the order.

8. A method for purchasing a financial instrument traded in a first currency using a second currency, a predetermined amount of the first currency being purchased with the second currency to settle an order for the financial instrument placed in the first currency, the method comprising the steps of:
a) applying at least one substantially real time series of currency conversion quotes to a currency conversion model adapted to estimate a plurality of future currency conversion quotes and a plurality of risk values associated with the plurality of future currency conversion quotes, each future currency conversion quote including a conversion price and a transaction time;
b) using an algorithm that includes parameters for the plurality of future currency conversion quotes and the associated plurality of risk values estimated in step (a) to determine an expected transaction time, the expected transaction time being before a settlement time of the order and determined to obtain a minimum conversion price within a set of risk criteria;
c) repeating steps (a) and (b) to update the expected transaction time until a current time is approximately the expected transaction time; and
d) purchasing the predetermined amount of the first currency with the second currency at a best current conversion price.

9. The method according to claim 8, wherein:
the algorithm used in step (b) further includes a parameter for the predetermined amount of the first currency to be purchased; and
the set of risk criteria depend on the predetermined amount of the first currency to be purchased.

10. The method according to claim 8, wherein the set of risk criteria depend on a time period between the current time and the settlement time.

11. The method according to claim 8, wherein:
the set of risk criteria include a plurality of subsets of partial purchase risk criteria, each subset of partial purchase risk criteria being associated with a partial purchase of the predetermined amount of the first currency;
step (b) includes the steps of:
b1) selecting a subset of partial purchase risk criteria; and
b2) using the algorithm to determine the expected transaction time such that obtains the minimum conversion price within the selected subset of partial purchase risk criteria; and
step (d) includes the steps of:
d1) purchasing a portion of the predetermined amount of the first currency with the second currency at a best current conversion price;
d2) removing the selected subset of partial purchase risk criteria from the set of risk criteria; and
d3) repeating steps (a), (b), (c), and (d) until the entire predetermined amount of the first currency is purchased.
